(19) United States
(12) Patent Application Publication
(10) Pub. No.: US 2010/0115820 A1
(43) Pub. Date: May 13, 2010

(54) PERFORATED SLAT TRAWL DOOR

(76) Inventors: Valentine Gavrilovich Perevoshchikov, Gurevsk (RU); Sherif Safwat, Bainbridge Island, WA (US)

Correspondence Address: DONALD E. SCHREIBER, POST OFFICE BOX 2926, KINGS BEACH, CA, 96143-2926, US

(21) Appl. No.: 12/451,032

(22) PCT Filed: Apr. 23, 2008
(86) PCT No.: PCT/EP2008/054958

§ 371 Date: Oct. 23, 2009

Related U.S. Application Data
(60) Provisional application No. 60/926,034, filed on Apr. 24, 2007.

(30) Foreign Application Priority Data
Nov. 20, 2007 (IS) 8691

(51) Int. Cl. A01K 73/02; A01K 79/00

(52) U.S. Cl. 43/4.5; 43/9.7

(57) ABSTRACT

A trawl door (20, 60) or a paravane (120, 140) having at least one main deflector (22, 22U, 22L) includes a permeable structure disposed adjacent to and separated from an outer surface (34) of the main deflector (22, 22U, 22L). The permeable structure extends from near a trailing edge (26, 26U, 26L) of the main deflector (22, 22U, 22L) over and separated from the outer surface (34) toward the main deflector's leading edge (24, 24U, 24L). In one embodiment of the permeable structure, a plurality of apertures (54, 56) pierce a perforated slat (52, 52U, 52L) thereby establishing a porous surface adjacent to the outer surface (34) of the main deflector (22, 22U, 22L). Adding the permeable structure perforated slat (52, 52U, 52L) to a trawl door (20, 60) increases the trawl door's stability when the trawl door is towed through water at a high angle of attack, and also reduces the trawl door's drag when operating at a high angle of attack.

### TECHNICAL FIELD

The present disclosure relates generally to trawl doors, and, more particularly, to trawl doors adapted for stable, more efficient operation at high angles of attack.

### BACKGROUND ART

A trawl is a large net generally in the shape of a truncated cone trailed through a water column or dragged along a sea bottom to gather marine life including fish. Methods and apparatuses for spreading a trawl trailed behind a moving towing vessel, frequently identified as “trawl doors,” are well known. Usually, a trawl door attaches to a towing vessel by a single main towing warp or other towing line secured to the trawl door near or at the trawl door's midpoint. The trawl then attaches to the trawl door by a pair of towing bridles, i.e. an upper and a lower towing bridle, respectively secured to the trawl door at or near opposite ends thereof. Trawl doors are also identified by other names, most commonly including “otter boards” and “doors”. Trawl doors, when used in the seismic industry are often referred to as “deflectors,” and may have several main “wings”, main “plates” and/or “slats.”

While a towed trawl door having a particular shape may operate stably throughout a range of angle of attack, when towed through water at a high angle of attack most trawl doors exhibit instability and/or low efficiency, i.e. high drag. It is important to note that usage and meaning of the term “high angle of attack” varies from fishery to fishery. Furthermore, trawl doors otherwise configured for a certain angle of attack when aboard ship ultimately fish at different angles of attack depending upon the lengths respectively of the sweep and/or bridles coupled to the trawl door. Similarly, the lengths respectively of a trawl's footropes and headropes can affect a trawl door's angle of attack while being towed through water. Moreover, how the towing vessel maneuvers can vary a trawl door's angle of attack. Lastly, the preceding factors that affect a towed trawl door's actual angle of attack do not do so independently. Rather, these factors act in concertedly in affecting a towed trawl door's actual operating angle of attack.

At a high angle of attack such as over thirty degrees) (30°), and especially at over thirty-five degrees (35°, most trawl doors exhibit instability and/or low efficiency, i.e. high drag. However, trawl doors commonly operate at such high angles of attack to create enough drag induced directional forces on the trawl doors so as to impart sufficient stability to the trawl door system to thereby maintain the trawl doors in a workable orientation. For example, when a towing vessel turns the inboard trawl door can become almost stationary relative to the water. As is readily apparent, slowing a trawl door down in relationship to the water reduces its spreading force, i.e. the trawl door's drag induced directional force. A similar situation can arise when a trawl door experiences a strong side current. Another condition which can cause trawl door instability occurs when some portion of the trawl contacts the sea floor. As is readily apparent, a trawl contacting the sea floor increases the force applied to the trawl door through the lower towing bridle in comparison with the force applied through the upper towing bridle. Stabilizing trawl doors when they operate under conditions such as those described above usually requires that the trawl doors operate at a high angle of attack.

A significant handicap of known trawl doors is that trawling vessels using trawl doors operating at a high angle of attack, such as in the Alaskan Pollock fishery, rarely make a “gear down” turn. Rather some trawl operators retrieve the trawl doors at or near the surface before making an efficient direction changing turn. If the trawl doors are not at or near the surface during a turn they tend to stall, i.e. loose their ability to spread and thus keep separate from one another. When the trawl doors lose their ability to spread they may tangle with each other, a phenomenon known as “crossing the doors”. Because remedying “crossed trawl doors” is a dangerous, and because it is also a time consuming procedure, some trawl operators prefer to retrieve the trawl doors at or near the surface before making a turn rather than risk “crossing the doors”.

It is well known that a particular species of fish usually concentrates at a certain ocean depth. Thus fishing at the certain ocean depth at which the fish species concentrates tends to avoid catching a significant quantity of unwanted fish species, i.e. by-catch. A drawback associated with retrieving trawl doors in order to turn efficiently is that the trawl correspondingly rises from the particular ocean depth at which the desired fish species concentrates. Thus, trawl door retrieval tends to catch unwanted species of fish (by-catch) while the trawl first ascends and then descends through various ocean depths during and after trawl door retrieval. Furthermore, many trawl operators find retrieving trawl doors in order to turn a tiresome affair. Such operators, therefore, often avoid turning, but rather remain on a course through portions of the ocean where the desired fish species are less concentrated. Unfortunately, towing a trawl through a less productive area of an ocean also tends to increased by-catch. For the preceding reasons, there exists a long felt need for a trawl door that operates stably and efficiently, e.g. exhibits lower drag, and/or generally exhibits a better lift constant “u” at high angles of attack, e.g. thirty degrees (30°) or more.

The instability exhibited by trawl doors when operating at a high angle of attack can be attributed to a phenomenon frequently referred to as “dynamic stall.” An airfoil or hydrofoil stalls when fluid flowing past the airfoil or hydrofoil separates therefrom. Stall may be a steady type wherein the location at which the flow separates from the airfoil or hydrofoil is essentially stationary. Alternatively, flow separation may be of an unsteady type wherein the separation location with respect to the airfoil or hydrofoil varies with time and flow conditions. In the scientific literature for fluid dynamics, dynamic stall of helicopter rotor blades and rotating stall of axial compressor blades provide well recognized examples of undesirable consequences resulting from unsteady flow separation. If unchecked, large oscillatory forces and moments produced in both types of stall can result in severe structural damage and erratic performance of such devices.

As described in “Evaluation of Turbulence Models for Unsteady Flows of an Oscillating Airfoil” by G. R. Srinivasan, J. A. Ekaterinaris and W. J. McCroskey, Computers & Fluids, vol. 24, no. 7, pp. 833-861, the term dynamic stall usually refers to the unsteady separation and stall phenomena of aerodynamic bodies or lifting surfaces. As described in U.S. Pat. No. 6,267,331 (“the '331 patent), a dominant feature characterizing dynamic stall on an airfoil or hydrofoil is a strong vortical flow, which begins near the leading-edge, enlarges, and then travels downstream along the foil. When a airfoil or hydrofoil reaches fairly high angles of attack, past the static stall angle limit, the resulting unsteady flowfield is characterized by massive separation and large-scale vortical structures. One important difference between this flowfield structure and that generated by the static stall is the large hysteresis in the unsteady separation and reattachment process. When dynamic stall occurs maximum values of lift, drag, and pitching-moment coefficients can greatly exceed their static counterparts, and not even the qualitative behavior of these conditions can be reproduced by neglecting the unsteady motion of the airfoil's or hydrofoil's surface. Typically, the problem of dynamic stall is addressed by some form of airfoil geometry modification (e.g. leading-edge slat), or boundary-layer control (e.g. blowing or suction), where these changes are geared specifically to the leading-edge region where the vortex originates. The '331 patent states that all methods of dynamic stall control that have been attempted heretofore have been less than satisfactory. There is thus a widely recognized need for, and it would be highly advantageous to have, a more satisfactory method of dynamic stall control for airfoils and hydrofoils than methods now known in the art.

### DEFINITIONS

ASPECT RATIO: means the Trawl Door Height relative to the Trawl Door Width. For example, a trawl door having a height of two (2) meters and a width of one (1) meter has an Aspect Ratio of 2:1 (two to one).
PROFILE: means the cross-sectional shape of a trawl door, or of a portion of a trawl door, viewed in a plane that is oriented perpendicularly across the trawl door's vertical dimension.
TRAWL DOOR: means any of a variety of essentially rigid structures having generally rigid deflectors (e.g. not formed of a foldable fabric as a kite) that is adapted for deployment in a body of water behind a towing vessel. More specifically, trawl door means any generally wing shaped and/or fin shaped device used to spread either a fishing net, such as a trawl, or to spread a seismic surveillance array and/or seismic array, such as used in making acoustic surveillance of a sea floor and sub-sea-floor, or to spread apart any other towed item, whether in air or sea. A trawl door usually attaches at a fore end to a terminal end of a main towing warp or other towing line depending from the towing vessel, and at an aft end to at least one other line itself ultimately attached to another towed item. In operation, trawl doors convert a portion of forward motion and/or energy imparted by the towing vessel into horizontally directed force for the purpose of spreading in a generally horizontal direction a trawl, seismic surveillance towed array complex, paravane line or the like.
TRAWL DOOR HEIGHT: the height of a trawl door is defined by the shortest distance between the trawl door's upper edge and the trawl door's lower edge. The Trawl Door Height measurement generally does not include any part of a purely weight shoe, wear plate, or the like, but rather relates to the portion of the trawl door's structure that is capable of efficiently generating lift and/or thrust.
TRAWL DOOR WIDTH: the width of a trawl door is defined by the shortest distance between the trawl door leading and trailing edges as taken from a profile of a portion of the trawl door. For trawl doors with straight leading and trailing edges, the width is generally the same everywhere along the vertical dimension of the trawl door. For a trawl door with a “swept back” configuration, the trawl door's width also may be expressed as an average of a sum of several trawl door width measurements taken at various profile locations located at varying positions along the vertical dimension of the trawl door, as such trawl doors typically have narrower widths at their extremities than at the middle thereof.

### DISCLOSURE

An object of the present disclosure is to provide a more stable trawl door.

Yet another object of the present disclosure is to provide a trawl door that operates more efficiently at a high angle of attack, such as at greater than thirty degrees (30°), and particularly greater than thirty-six degrees (36°) including forty degrees (40°).

Briefly, an improved trawl door adapted for being towed through water includes at least one main deflector. The main deflector has a profile formed by inner and outer surfaces. The profile of the main deflector spans a chord that extends between the main deflector's leading and trailing edges, and has a maximum thickness. The improved trawl door is characterized by including a permeable structure for bettering, in comparison with the trawl door lacking the permeable structure, at least one trawl door efficiency characteristic selected from a group consisting of:
1. trawl door stability when the trawl door is towed through water at a high angle of attack;
2. trawl door drag;
3. a numerical value obtained by dividing a lift coefficient measured for the improved trawl door by a drag coefficient measured for the improved trawl door; and
4. noise generation.
   At least a portion of the improved trawl door's permeable structure is situated adjacent to and separated from the outer surface of the main deflector, and between the main deflector's maximum thickness and its trailing edge.

In one embodiment, a perforated slat, having a plurality of apertures formed therethrough, provides the permeable structure. Thus, the perforated slat permeable structure establishes a porous surface adjacent to the main deflector's outer surface. In another embodiment, a plurality elongated strips of solid material that are separated by a longitudinal gap therebetween provides the permeable structure. The elongated solid material strips, which have both a length and a width, have their length oriented mainly parallel to water flowing past the towed trawl door's main deflector. Correspondingly, the elongated solid material strips' widths are oriented mainly orthogonal to water flowing past the towed trawl door's main deflector.

Advantages provided by a trawl door that employs a permeable structure in accordance with the present disclosure when operating at a high angle of attack, such as at greater than thirty degrees (30°) and particularly greater than thirty-six degrees (36°) including greater than forty degrees (40°), is that trawl door stability increases, the trawl door's angular operating range increases, and attainable trawl door lift and consequently trawl-mouth spreading force increases in comparison with the same characteristics exhibited by a conventional trawl door when configured for operation at a correspondingly high angle of attack.

Another advantage of the improved trawl door structures is less noise generation in comparison with conventional trawl doors. The improved trawl door structure produce significantly less wake turbulence compared to conventional trawl door structures. Less wake turbulence corresponds to less noise generation which is particularly advantageous when towing paravanes included in seismic surveillance arrays. Seismic surveillance uses arrays of microphones towed behind a vessel for collecting acoustic data for subsequent processing to produce images of underwater structures. As is readily apparent, paravane noise generation compromises the quality of underwater seismic surveillance images.

These and other features, objects and advantages will be understood or apparent to those of ordinary skill in the art from the following detailed description of the preferred embodiment as illustrated in the various drawing figures.

### BRIEF DESCRIPTION OF DRAWINGS

FIG. 1 is a perspective drawing illustrating one embodiment for a trawl door in accordance with the present disclosure that includes only one (1) main deflector and that has straight leading and trailing edges, the disclosed trawl door includes a porous perforated slat disposed adjacent to, separated from, and supported from an outer surface of the main deflector;

FIG. 2 is a cross-sectional diagram taken along the line 2-2 in FIG. 1 illustrating a profile of the trawl door depicted in that FIG.;

FIG. 3 is a plan view illustrating part of the trawl door depicted in FIG. 1 taken along the line 3-3 in FIG. 2;

FIG. 4 is a cross-sectional diagram that corresponds to the illustration of FIG. 2 and that illustrates a specific configuration for the trawl door's perforated slat and main deflector providing detailed information about relative sizes for various curved components included in the trawl door;

FIG. 5 is a plan view similar to the illustration of FIG. 3 that illustrates a specific configuration for the trawl door's perforated slat having a plurality of elongated, rectangularly-shaped perforations formed therethrough with the longest dimension of the perforations oriented parallel to the chord of the main deflector;

FIG. 6 is a plan view similar to the illustration of FIG. 3 that illustrates another specific configuration for the trawl door's perforated slat having a plurality of elongated, rectangularly-shaped perforations formed therethrough with the shortest dimension of perforations through the perforated slat oriented parallel to the chord of the main deflector;

FIG. 7 is a plan view similar to the illustration of FIG. 3 that illustrates yet another specific configuration for the trawl door's perforated slat having a plurality of circularly shaped perforations formed therethrough rather than rectangularly shaped perforations as depicted in FIGS. 5 and 6;

FIG. 8 is a plan view similar to the illustration of FIG. 3 that illustrates yet another specific configuration for the trawl door's perforated slat having a plurality of elongated, rectangularly-shaped perforations formed therethrough with some of the perforations having their longest dimension oriented parallel to the chord of the main deflector while others of the perforations have their shortest dimension oriented parallel to the main deflector's chord;

FIGS. 9A through 9C are plan views of portions of the perforated slat illustrating respectively alternative round-shaped, prong-shaped and pointed-shaped ends for the elongated, rectangularly-shaped perforations formed through the perforated slat depicted in FIGS. 3, 5, 6, and 8;

FIGS. 10A and 10B are perspective drawings respectively illustrating a top surface and under surface of a Vee-shaped (dihedral) trawl door in accordance with the present disclosure that includes two (2) abutting main deflector bodies joined together at the middle of the trawl door, and the trawl door also includes two (2) perforated slats which are respectively disposed adjacent to and separated from the outer surface of the respective main deflector bodies;

FIG. 11 depicts relationships existing among FIGS. 11A, 11B, 11C and 11D, the combined FIGS. 11A-11D forming a spreadsheet that provides detailed technical information useful in constructing trawl doors in accordance with the present disclosure;

FIG. 12 is a perspective drawing illustrating a paravane adapted for inclusion in seismic surveillance array that includes four (4) main deflectors only one (1) of which includes a perforated slat;

FIG. 13 is a cross-sectional diagram taken along the line 13-13 in FIG. 12 illustrating a profile of the paravane depicted in that FIG.;

FIG. 14 is a perspective drawing illustrating a paravane adapted for inclusion in seismic surveillance array that includes four (4) main deflectors each of which includes a perforated slat; and

FIG. 15 is a cross-sectional diagram taken along the line 15-15 in FIG. 14 illustrating a profile of the paravane depicted in that FIG.

### BEST MODE FOR CARRYING OUT THE DISCLOSURE

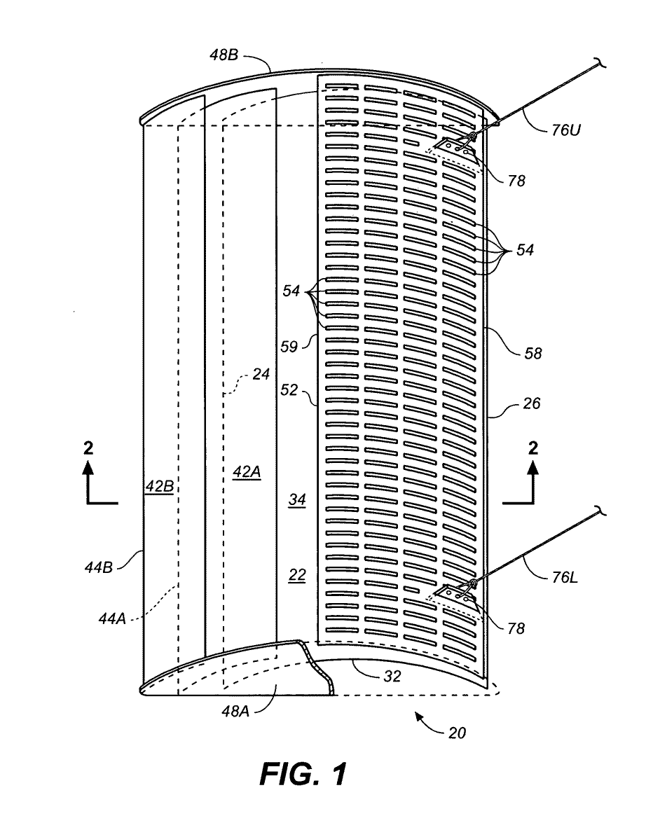

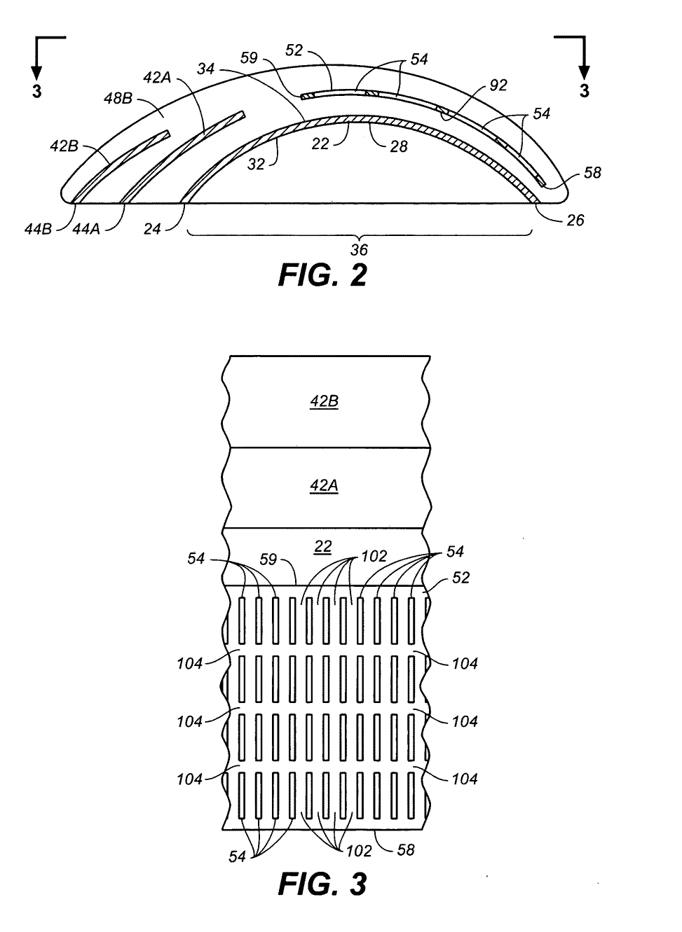

The perspective drawing of FIG. 1 illustrates an improved trawl door in accordance with the present disclosure referred to by the general reference character 20. The trawl door 20 includes a main deflector 22 having a leading edge 24 and a trailing edge 26, best illustrated by the profile of the trawl door 20 depicted in FIG. 2. In the embodiment of the trawl door 20 illustrated in FIGS. 1-3, a cambered steel plate forms the main deflector 22. For the particular profile illustrated in FIG. 2, the main deflector 22 has a maximum thickness 28 that is located approximately half way between the leading edge 24 and the trailing edge 26. The steel plate forming the main deflector 22 has a cambered inner surface 32 and a cambered outer surface 34 which respectively span a chord 36 of the main deflector 22 that extends between the leading edge 24 and the trailing edge 26. The trawl door 20 also preferably includes a leading edge lift enhancing structure consisting of a pair of cambered leading edge slats 42A and 42B that, similar to the main deflector 22, are formed by cambered steel plates. A leading edge 44B of the leading edge slat 42B disposed furthest from the leading edge 24 of the main deflector 22 forms a leading edge of the trawl door 20. A leading edge 44A of the leading edge slat 42A is disposed between the leading edge 44B and the leading edge 24.

In addition to the main deflector 22 and the leading edge slats 42A and 42B, the trawl door 20 also includes lower and upper end plates 48A, 48B. Opposite ends of to the main deflector 22 and the leading edge slats 42A and 42B are respectively fastened to the lower and upper end plates 48A, 48B, e.g. by welding, to establish and maintain the relationship among various parts of the trawl door 20. Except for any mention of a permeable structure, the structure of the trawl door 20 as disclosed thus far is conventional and well known in the art.

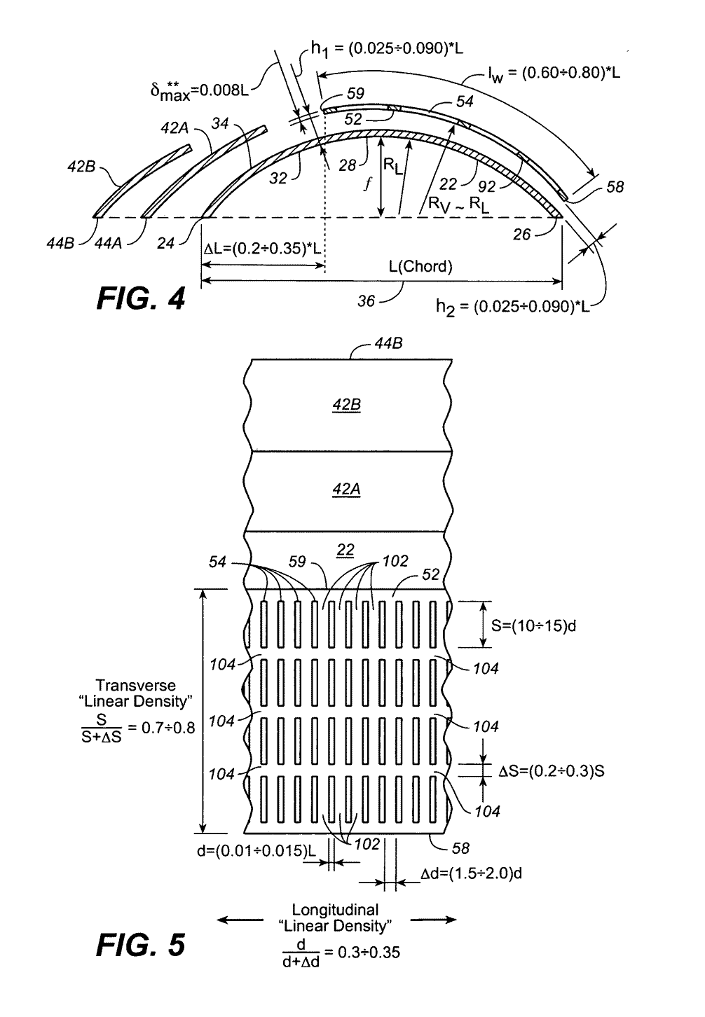

The improved trawl door 20 further includes a permeable structure depicted in FIGS. 1-3 and called a perforated slat 52 that is disposed adjacent to and separated from the outer surface 34 of the main deflector 22. The perforated slat 52 extends from a trailing edge 58, that is located near the trailing edge 26 of the main deflector 22, part way over and separated from the outer surface 34 toward the leading edge 24 of the main deflector 22 to a leading edge 59. Preferably, at least a portion of the perforated slat 52 is situated adjacent to and separated from the outer surface 34 of the main deflector 22 between the maximum thickness 28 of the main deflector 22 and the trailing edge 26 thereof. As indicated for the profile of the particular trawl door 20 depicted in FIGS. 2 and 4, the letter parameter “f” indicates the measure of the maximum thickness 28 extends from the chord 36 of the main deflector 22 to the main deflector 22.

Similar to the main deflector 22 and the leading edge slats 42A and 42B, the perforated slat 52 depicted in FIGS. 1-3 is formed by a cambered steel plate. Also similar to the main deflector 22 and the leading edge slats 42A and 42B, opposite ends of the perforated slat 52 are respectively secured to the lower and upper end plates 48A, 48B, e.g. by welding. The perforated slat 52 depicted in FIG. 3 differs from the main deflector 22 and the leading edge slats 42A and 42B by being pierced by a plurality of elongated, rectangularly-shaped perforations 54. Furthermore, due to the rectangularly-shaped perforations 54 piercing the sheet material of the perforated slat 52, to make the trawl door 20 structurally sound the perforated slat 52 is preferably secured to the main deflector 22 via support structures welded at selected locations along its length. In the particular embodiment of the perforated slat 52 depicted in FIGS. 1-3, the rectangularly-shaped perforations 54 are arranged in parallel rows with their longer dimension oriented within thirty degrees (30°) of parallel to the chord 36 of the main deflector 22, and preferably within 20 degrees (20°) and even more preferably within fifteen degrees (15°).

The cross-sectional diagram of FIG. 4 illustrates a specific configuration for the perforated slat 52 and the main deflector 22 providing detailed technical information about relative sizes for various cambered components included in the trawl door 20. Specific design information for the main deflector 22 and the perforated slat 52 appearing in FIG. 4 scales from the length (“L”) of the chord 36 of the circular arc of the cambered main deflector 22. The symbol “+” appearing between two numerical values in expressions in FIG. 4 and subsequent FIGs. indicates a range of values that extends from the first numerical value to the second numerical value. A single asterisk (“*”) in FIG. 4 denotes a value for the particular parameter so marked that has been empirically determined to yield the best improvement in lift for the main deflector 22 and perforated slat 52 having the structural relationships appearing in FIG. 4. The best values determined empirically for particular parameters when a ratio of the height of the circular arc-shaped main deflector 22 to the length of its chord 36 is in the range of 0.23 to 0.25 are tabulated below.

L_{W}=(0.70 to 0.80)L where L is the length of the chord 36

h₁=(0.045 to 0.075)L

h₂=(0.040 to 0.075)L

h₄≧h₂

ΔL=(0.24 to 0.33)L

A double asterisk (“**”) in FIG. 4 indicates the maximum permissible thickness for the perforated slat 52.

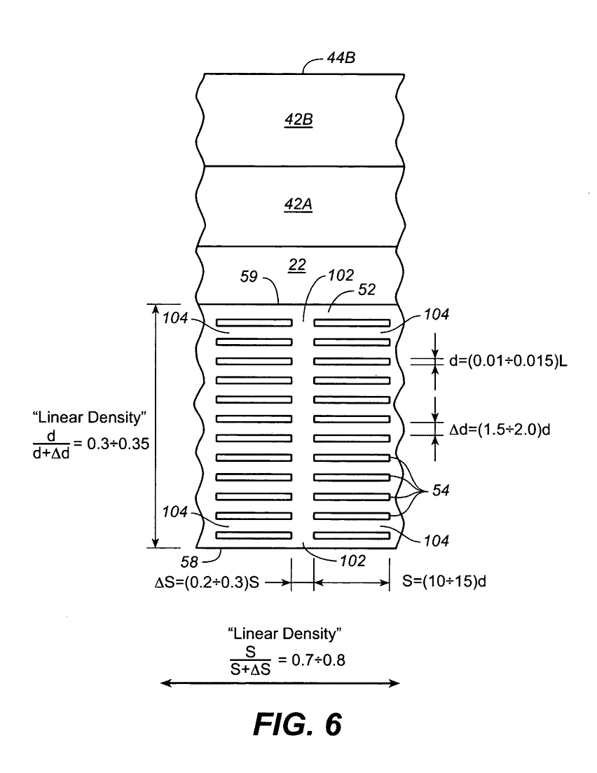

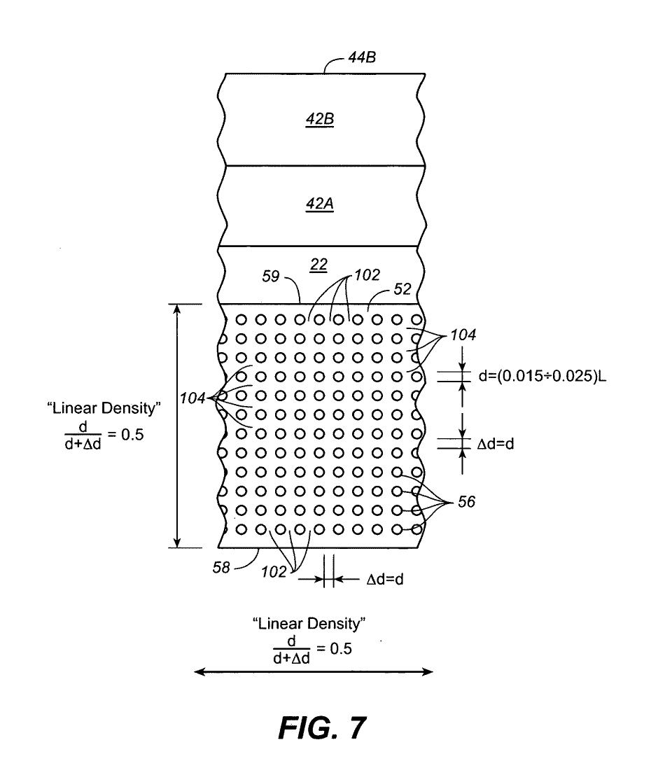

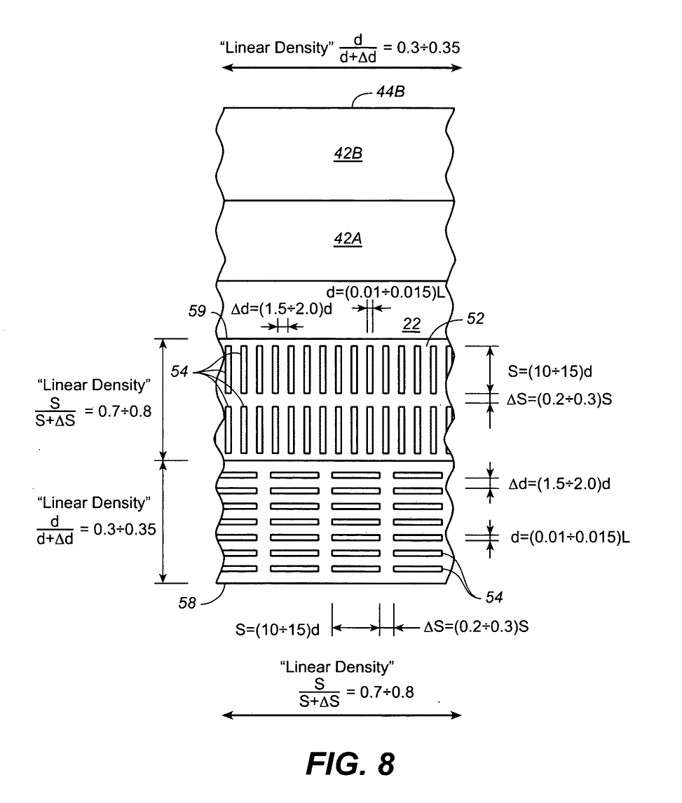

The plan views of FIGS. 5-8 illustrate various different configurations for apertures formed through the perforated slat 52 for the specific arrangement of the trawl door 20 depicted in the cross-sectional diagram of FIG. 4. The plan view of FIG. 5 provides parametric values for a specific configuration of the rectangularly-shaped perforations 54 having the longest dimension of the rectangularly-shaped perforations 54 oriented parallel to the chord 36 of the main deflector 22. The plan view of FIG. 6 provides parametric values for a specific configuration of the rectangularly-shaped perforations 54 having the shortest dimension of the rectangularly-shaped perforations 54 oriented parallel to the chord 36 of the main deflector 22. The plan view of FIG. 7 depicts an embodiment of the perforated slat 52 having circularly-shaped perforations 56 formed through sheet material of the perforated slat 52, and provides parametric values for such circular apertures. The plan view of FIG. 8 provides parametric values for a specific configuration of the rectangularly-shaped perforations 54 some of which have their longest dimension oriented parallel to the chord 36 of the main deflector 22 while others have their shortest dimension oriented parallel to the chord 36.

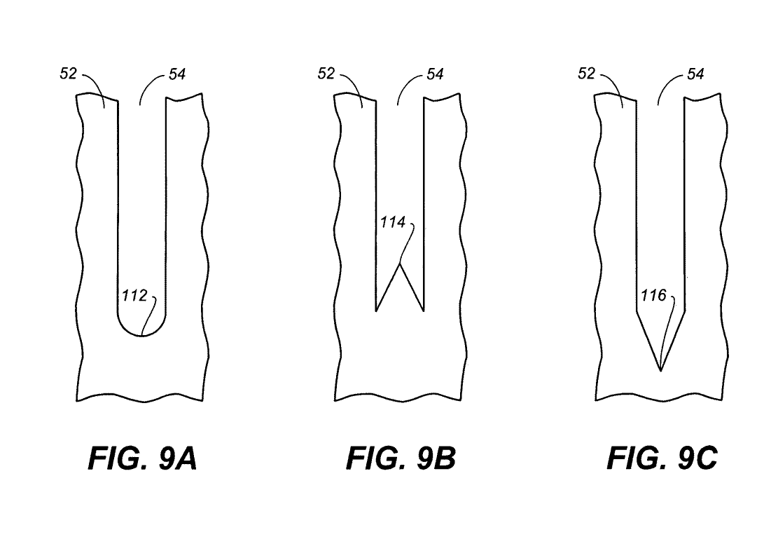

FIGS. 1-8 depict rectangularly-shaped perforations 54 or circularly-shaped perforations 56 arranged in parallel rows to provide the porous surface located adjacent to the outer surface 34 of the main deflector 22. As depicted in FIGS. 5-8, forming the rectangularly-shaped perforations 54 with a length to width ratio in a range of 10:1 to 15:1 can be advantageous. However, in accordance with the present disclosure apertures formed through the perforated slat 52 may have shapes other than the rectangularly-shaped perforations 54 and/or circularly-shaped perforations 56, and which differ in size, orientation and arrangement relative to the chord 36 and/or to the leading and trailing edges 24, 26 of the main deflector 22. The plan views of FIGS. 9A through 9C depict portions of the perforated slat 52 illustrating, respectively, alternative shapes for short ends of rectangularly-shaped perforations 54 formed therethrough. FIG. 9A illustrates a rectangularly-shaped perforation 54 having a short end formed with a round-shape 112. FIG. 9B illustrates a rectangularly-shaped perforation 54 having a short end formed with a prong-shape 114. And FIG. 9C illustrates a rectangularly-shaped perforation 54 having a short end formed with a pointed-shape 116. In general, a configuration selected for a particular embodiment of the trawl door 20 including the main deflector 22 and the perforated slat 52 and of the apertures which make the perforated slat 52 porous must be determined empirically, preferably by experimentally testing models of the trawl door 20 in a flume tank.

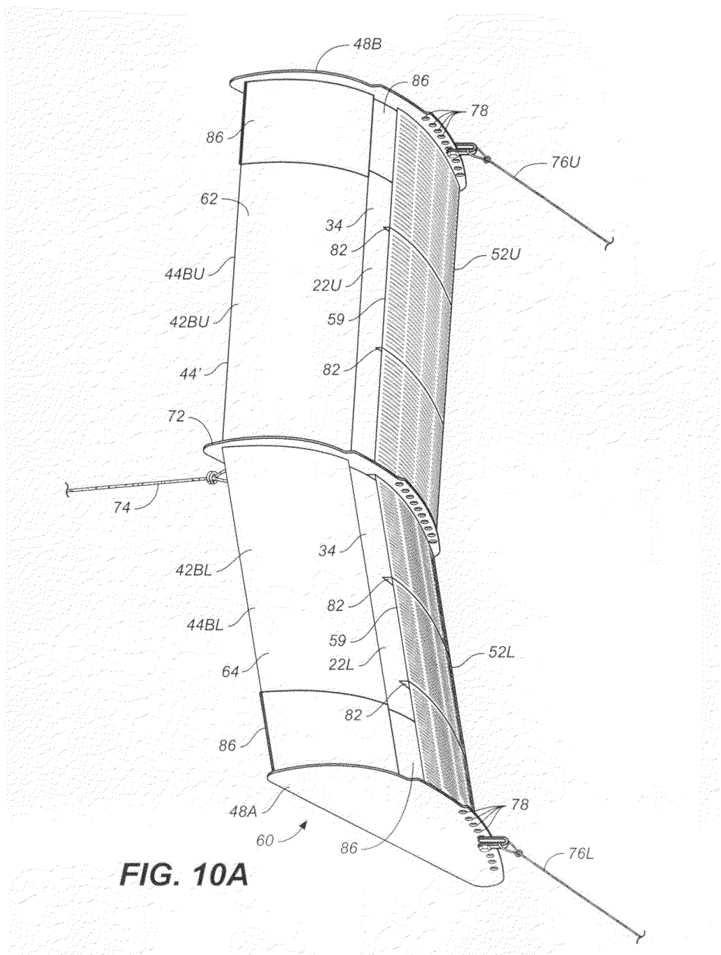

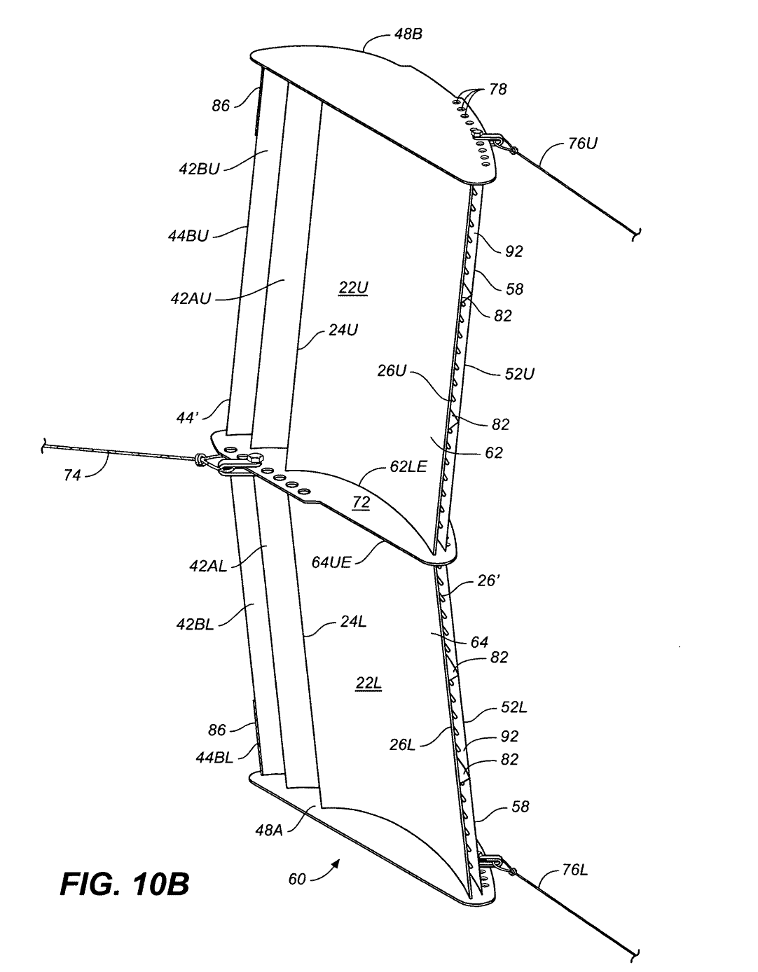

The perspective drawings of FIGS. 10A and 10B illustrate an improved Vee-shaped (dihedral) trawl door in accordance with the present disclosure referred to by the general reference character 60. The trawl door 60 includes a upper trawl door section 62 and a lower trawl door section 64. Individually, the upper trawl door section 62 and lower trawl door section 64 depicted in FIGS. 10A and 10B are very similar in structure to the trawl door 20 depicted in FIGS. 1-3. The upper and lower trawl door sections 62, 64 abut each other along a lower edge 62LE of the upper trawl door section 62 that faces an upper edge 64UE of the lower trawl door section 64 along a center plate 72. Similar to the trawl door 20 depicted in FIG. 1, the trawl door 60 includes a lower end plate 48A and an upper end plate 48B. Corresponding exterior surfaces of the upper trawl door section 62 and lower trawl door section 64 respectively lie in different planes thereby providing the trawl door 60 with its Vee-shape, i.e. dihedral. Preferably, leading and trailing edges of the trawl door 60 are straight, i.e. not ‘swept back.’

The upper trawl door section 62 includes an upper main deflector 22U formed by a cambered steel plate, and that has an upper leading edge 24U and an upper trailing edge 26U. The upper trawl door section 62 also preferably includes a leading edge lift enhancing structure consisting of a pair of upper leading edge slats 42AU and 42BU that, similar to the upper main deflector 22U, are formed by cambered steel plates. The upper leading edge slat 42BU has an upper leading edge 44BU that is disposed furthest from the upper leading edge 24U of the upper main deflector 22U.

The lower trawl door section 64 includes a lower main deflector 22L formed by a cambered steel plate, and that has a lower leading edge 24L and a lower trailing edge 26L. The lower trawl door section 64 also preferably includes a leading edge lift enhancing structure consisting of a pair of lower leading edge slats 42AL and 42BL that, similar to the lower main deflector 22L, are formed by cambered steel plates. The lower leading edge slat 42BL has a lower leading edge 44BL that is disposed furthest from the lower leading edge 24L of the lower main deflector 22L. The combined upper leading edge 44BU of the upper leading edge slat 42BU and lower leading edge 44BL of the lower leading edge slat 42BL form a leading edge 44′ of the trawl door 60. Similarly, the combined upper trailing edge 26U of the upper main deflector 22U and lower trailing edge 26L of the lower main deflector 22L form a trailing edge 26′ of the trawl door 60. Except for any possible description of a perforated slat, the structure of the trawl door 60 depicted in FIGS. 10A and 10B and as disclosed thus far is conventional and well known in the art.

The center plate 72 of the trawl door 60 depicted in FIGS. 10A and 10B is part of a load bearing frame that transmits towing loads from the towing vessel to the towed trawl or other item. Accordingly, when the trawl door 60 is assembled into a trawl system, a main towing warp 74 attaches to the trawl door 60 at any one of several different locations fore and aft along the center plate 72. Similarly, a lower towing bridle 76L attaches to one of several backstrop holes 78 that pierce the lower end plate 48A of the trawl door 60 while an upper towing bridle 76U attaches to one of several backstrop holes 78 that similarly pierce the upper end plate 48B.

Note that the illustration of the trawl door 20 in FIG. 1 omits the main towing warp 74, and depicts only the lower towing bridle 76L and the upper towing bridle 76U. Note further that instead of the lower towing bridle 76L attaching to the lower end plate 48A and the upper towing bridle 76U attaching to the upper end plate 48B, for the trawl door 20 depicted in FIG. 1 the lower towing bridle 76L and the upper towing bridle 76U both attach to backstrop holes 78 formed through plates which project outward from the outer surface 34 of the main deflector 22 and through the perforated slat 52 respectively near opposite ends thereof.

Similar to the trawl door 20, the upper trawl door section 62 of the trawl door 60 further includes both a perforated upper perforated slat 52U disposed adjacent to and separated from an outer surface 34 of the upper main deflector 22U, and a perforated lower perforated slat 52L disposed adjacent to and separated from an outer surface 34 of the lower main deflector 22L. The upper perforated slat 52U and the lower perforated slat 52L respectively extend from near the trailing edge 26′ of the trawl door 60 partway over and separated from the outer surfaces 34 respectively of the upper main deflector 22U and lower main deflector 22L toward the upper leading edge 24U and lower leading edge 24L thereof. Similar to the upper main deflector 22U, lower main deflector 22L, the upper leading edge slats 42AU and 42BU and the lower leading edge slats 42AL and 42BL, the lower perforated slat 52L and the upper perforated slat 52U depicted in FIGS. 10A and 10B are formed by cambered steel plates. Furthermore, due to apertures piercing the sheet material of the lower perforated slat 52L and upper perforated slat 52U, to make the trawl door 60 structurally sound the lower perforated slat 52L and upper perforated slat 52U are respectively secured to the lower main deflector 22L and upper main deflector 22U at selected locations 82 along their respective lengths. The lower perforated slat 52L and upper perforated slat 52U both being pierced by apertures provide a porous surface adjacent to the outer surfaces 34 respectively of the lower main deflector 22L and upper main deflector 22U.

When during normal use trawl doors, particular Vee-shaped (dihedral) trawl doors, contact the side of an undersea cliff, canyon wall, or lean over from improper setting or an extremely strong side current, nearly all impact damage occurs near tips of the trawl door's leading edge. The perspective view of FIG. 10A best illustrates leading edge wear plates 86 that may be included in a trawl door immediately inboard of the lower and upper end plates 48A, 48B of the trawl door 60. The wear plates 86 are formed by a second layer of steel laminated onto the material forming upper leading edge slats 42AU and 42BU and the lower leading edge slats 42AL and 42BL. Equipping the trawl door 60 and/or trawl door 20 with the wear plates 86 at distal ends thereof adjacent to the lower and upper end plates 48A, 48B increases the trawl door's useful service life.

The trawl doors 20, 60 may also include a mass weight plate, not illustrated in any of the FIGs, that attaches to the lower end plate 48A. Addition of amass weight plate increases the stability of the trawl doors 20, 60 during field operations by permitting selecting an appropriate amount of weight for the intended trawl door altitude in the water column.

In accordance with the present disclosure, when the trawl door 20 or 60 is towed through water at a high angle of attack, the trawl door 20 or 60 operates stably and exhibits less drag than the trawl door 20 without the perforated slat 52, or the trawl door 60 without the upper perforated slat 52U and lower perforated slat 52L.

### INDUSTRIAL APPLICABILITY

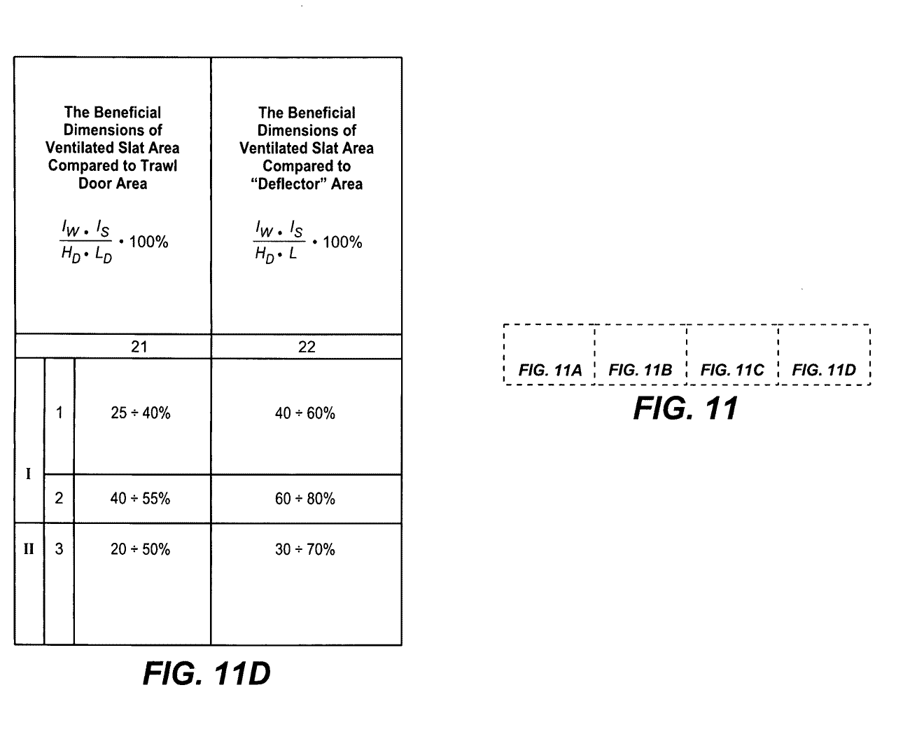

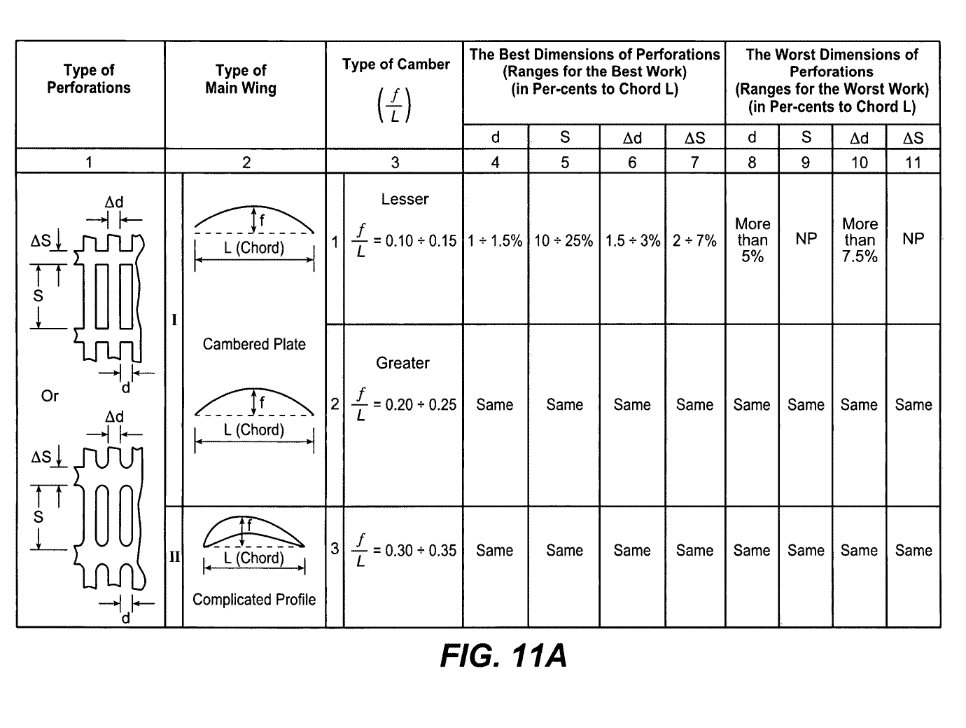

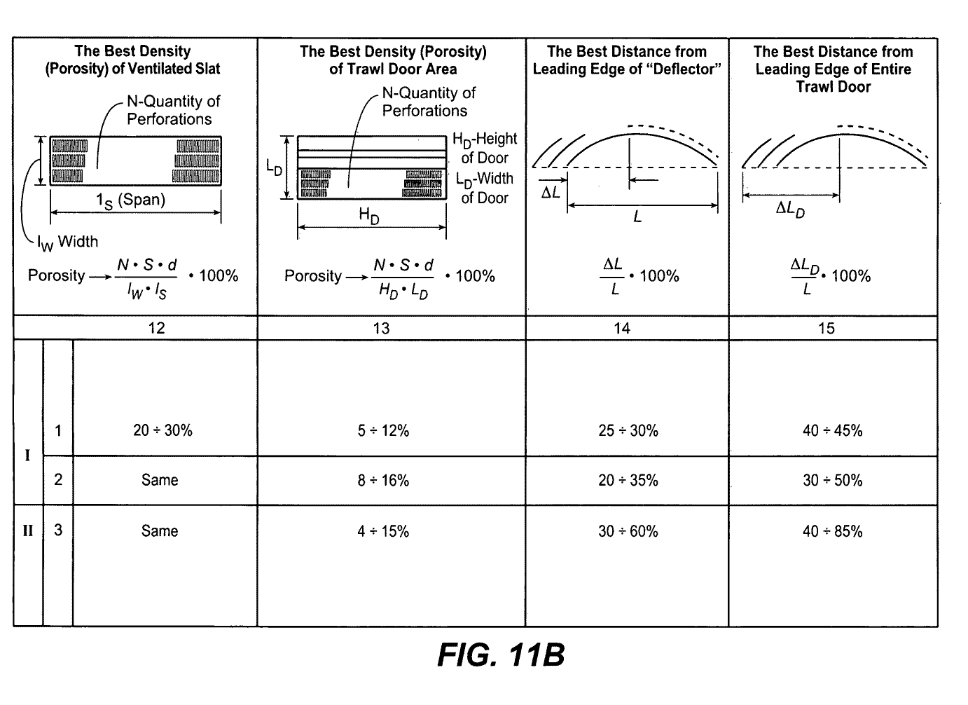

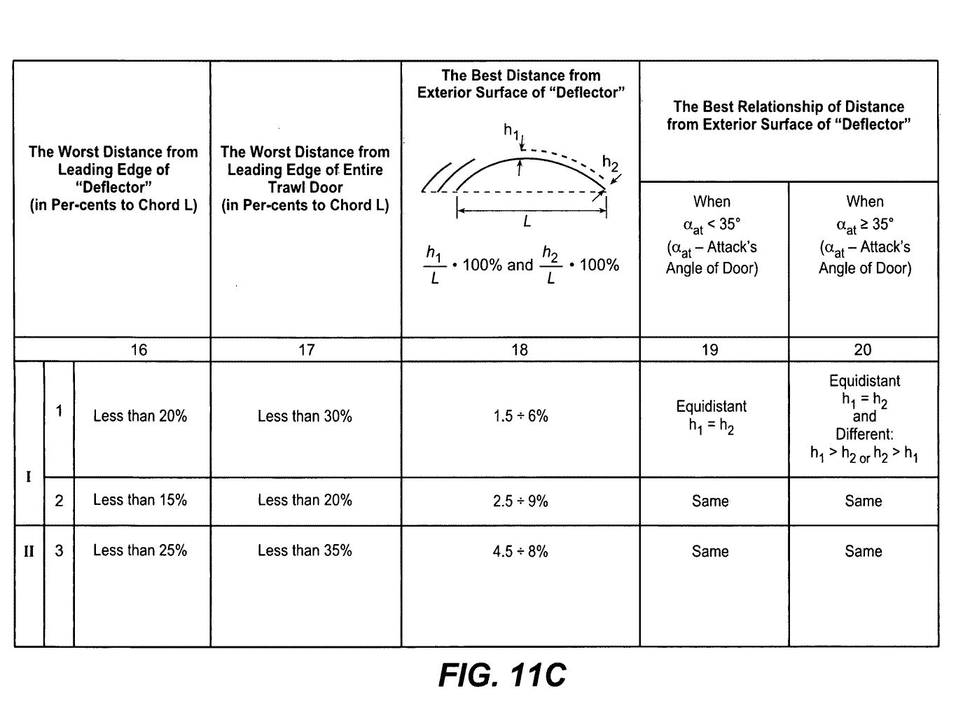

A spreadsheet assembled by juxtaposing FIGS. 11A-11D in the manner depicted in FIG. 11 provides detailed technical information useful in constructing trawl doors in accordance with the present disclosure. The spreadsheet formed by juxtaposing FIGS. 11A-11D includes numbered vertical columns 1-22 that extend from left to right. The bottom of column 1 at the left hand side of the spreadsheet depicts two (2) alternative shapes for apertures formed through the perforated slat 52 of trawl door 20, or formed through the upper perforated slat 52U and lower perforated slat 52L of the trawl door 60. These illustrations of shapes for apertures formed through the perforated slat 52, 52U or 52L include technical details about those particular shapes that are used elsewhere in the spreadsheet in providing additional detailed structural information. Column 2 in the spreadsheet depicts different profiles that may be used for the main deflector 22 of the trawl door 20 or for the upper main deflector 22U and lower main deflector 22L of the trawl door 60. Similar to the illustrations in column 1, these illustrations of shapes for the main deflector 22, 22U or 22L include technical details about those particular shapes that are used elsewhere in the spreadsheet in providing additional detailed structural information.

Beginning in column 3 and extending horizontally across the spreadsheet to column 22 are three (3) rows one above the other respectively labeled 1, 2 and 3 downward in FIG. 11A′s column 3, and similarly labeled adjacent to the left hand edge of FIGS. 11B-11D. In columns 3 through 22 these three (3) rows provide technical details pertinent to the alternative perforation shapes illustrated in column 1 for the two (2) different types of profiles depicted in column 2. Specifically, horizontal rows 1 and 2 in columns 3 through 22 provide technical details pertinent to the alternative perforation shapes illustrated in column 1 for two different configurations of the cambered plate profile depicted in the middle of column 2. In columns 3 through 22 horizontal row 3 provides technical details pertinent to the alternative perforation shapes illustrated in column 1 for the complicated profile depicted at the bottom of column 2.

Columns 4 through 11 in rows 1 through 3 provide ranges for relationships of preferred lengths to preferred widths for apertures formed through the perforated slat 52 of trawl door 20, or formed through the upper perforated slat 52U and lower perforated slat 52L of the trawl door 60 with respect to the chord 36 and to the camber of the main deflector 22, 22U or 22L. As disclosed in columns 4 and 5 of FIG. 11A, forming the rectangularly-shaped perforations 54 with a length to width ratio in a range of 20:3 to 50:3 can be advantageous. The notation “NP” appearing in columns 9 and 11 indicates that, presently, no definitive value has been ascertained for those particular parameters.

Column 12 of FIG. 11B in rows 1 through 3 provides a preferred range of porosities for the perforated slat 52 of trawl door 20 or the upper perforated slat 52U and lower perforated slat 52L of the trawl door 60 relative to the area of the cambered surface respectively of the main deflector 22, 22U or 22L. In general, it has been found that a total area for rectangularly-shaped perforations 54 and/or circularly-shaped perforations 56 formed through the perforated slat 52 of trawl door 20 or the upper perforated slat 52U or lower perforated slat 52L of the trawl door 60 that is between twenty percent (20%) and forty percent (40%) of the overall area of the perforated slat 52 of trawl door 20 or the upper perforated slat 52U or lower perforated slat 52L of the trawl door 60 achieves this disclosure's objectives and provides the advantages thereof. Particularly preferred for achieving this disclosure's objectives and providing its advantages is when the total area for rectangularly-shaped perforations 54 and/or circularly-shaped perforations 56 is between twenty percent (20%) and thirty percent (30%) of the overall area of the perforated slat 52, upper perforated slat 52U or lower perforated slat 52L.

Similar to column 12, column 13 provides a preferred range of porosities for the perforated slat 52 of trawl door 20 or the upper perforated slat 52U and lower perforated slat 52L of the trawl door 60 relative to the area OF the trawl door 20 including the main deflector 22 and the leading edge slats 42A and 42B, and the area of the trawl door 60 including the upper main deflector 22U, the upper leading edge slats 42AU and 42BU, the lower main deflector 22L and the lower leading edge slats 42AL and 42BL relative to the area of the cambered surface respectively of the main deflector 22, 22U or 22L.

Column 14 in FIG. 11B and column 16 in FIG. 11C provide information about a preferred range of distances parallel to the chord 36 from the leading edge 24 of the main deflector 22, 22U or 22L to the leading edge 59 of the perforated slat 52, 52U or 52L. In general, it has been found that a distance between the leading edge 24 respectively of the main deflector 22, 22U or 22L and the leading edge 59 respectively of the perforated slat 52, 52U or 52L parallel to the chord 36 of the main deflector 22, 22U or 22L that is between fifteen percent (15%) and sixty-five percent (65%) of a length of the chord 36 respectively of the main deflector 22, 22U or 22L achieves this disclosure's objectives and provides the advantages thereof. Particularly preferred for achieving this disclosure's objectives and providing its advantages for a cambered plate having the characteristics specified for row 1 of the spreadsheet is when the distance between the leading edge 24 respectively of the main deflector 22, 22U or 22L and the leading edge 59 respectively of the perforated slat 52, 52U or 52L parallel to the chord 36 of the main deflector 22, 22U or 22L is between twenty-five percent (25%) and thirty percent (30%) of the length of the chord 36 respectively of the main deflector 22, 22U or 22L. Particularly preferred for achieving this disclosure's objectives and providing its advantages for a cambered plate having the characteristics specified for row 2 of the spreadsheet is when the distance between the leading edge 24 respectively of the main deflector 22, 22U or 22L and the leading edge 59 respectively of the perforated slat 52, 52U or 52L parallel to the chord 36 of the main deflector 22, 22U or 22L is between twenty percent (20%) and thirty-five percent (35%) of the length of the chord 36 respectively of the main deflector 22, 22U or 22L. Particularly preferred for achieving this disclosure's objectives and providing its advantages for a complicated profile having the characteristics specified for row 3 of the spreadsheet is when the distance between the leading edge 24 respectively of the main deflector 22, 22U or 22L and the leading edge 59 respectively of the perforated slat 52, 52U or 52L parallel to the chord 36 of the main deflector 22, 22U or 22L is between thirty percent (30%) and sixty percent (60%) of the length of the chord 36 respectively of the main deflector 22, 22U or 22L. Similar to columns 14 and 16, column 15 in FIG. 11B and column 17 in FIG. 11C provide information about a preferred range of distances parallel to the chord 36 from the leading edge 44B of the leading edge slat 42B, 42BU or 42BL to the leading edge 59 of the perforated slat 52, 52U or 52L.

Rows 1 through 3 of columns 18 through 20 provide information about a separation distance between the outer surface 34 of the main deflector 22, 22U or 22L and the perforated slat 52, 52U or 52L. Column 18 in rows 1 through 3 provides preferred ranges for those separation distances. Column 19 provides information for angles of attack less than 35 degrees (35°) indicating that the separation distances between the perforated slat 52, 52U or 52L and the outer surface 34 of the main deflector 22, 22U or 22L are preferably the same both at the leading edge 59 and trailing edge 58 of the perforated slat 52, 52U or 52L. However, as presented in column 20, for angles of attack equal to or exceeding 35 degrees (35°) the separation distances between the perforated slat 52, 52U or 52L and the outer surface 34 of the main deflector 22, 22U or 22L can be:
1. identical at the leading edge 59 and trailing edge 58 of the perforated slat 52, 52U or 52L; or
2. the distance at the leading edge 59 can exceed that at the trailing edge 58.
   In general, it has been found that a spacing between an inner surface 92 of the perforated slat 52, 52U or 52L at the trailing edge 58 thereof to the immediately adjacent outer surface 34 of the main deflector 22, 22U or 22L that is between seventy-five percent (75%) and one-hundred and fifteen percent (115%) of the spacing between the inner surface 92 at the leading edge 59 of the perforated slat 52, 52U or 52L to the immediately adjacent outer surface 34 of the main deflector 22, 22U or 22L achieves this disclosure's objectives and provides the advantages thereof.

Column 21 provides preferred ranges for the area of the cambered surface perforated slat 52, 52U or 52L relative to the total area of all cambered surfaces of the trawl door 20 or the trawl door 60. Similarly, column 22 provides preferred ranges for the area of the cambered surface perforated slat 52, 52U or 52L relative to the area of the cambered surface main deflector 22, 22U or 22L.

All detailed technical information appearing in FIGS. 4-8 and in the spreadsheet appearing of FIGS. 11A-11D is hereby incorporated by reference as though fully set forth here. Accordingly, it is deemed that the detailed technical information appearing in appearing in FIGS. 4-8 and in the spreadsheet appearing of FIGS. 11A-11D appears at this point in this patent application thereby providing a comprehensive disclosure of such information.

Rather than focusing on characteristics of perforations 54, 56 piercing the perforated slat 52, 52U and 52L, a description of the trawl door 20 or 60 which complements that set forth above is one which characterizes solid material of the perforated slat 52, 52U and 52L. For the illustrations of FIGS. 2 and 5, this complementary description of the perforated slat 52, 52U and 52L focuses on a plurality elongated strips 102 of solid material each of which extends between immediately adjacent columns of rectangularly-shaped perforations 54 from the leading edge 59 to the trailing edge 58. For this characterization of the perforated slat 52, 52U and 52L, the strips 102 are:
1. disposed adjacent to and separated from the outer surface 34 of the main deflector 22; and
2. have both a length and a width.

In the illustration of FIG. 5, the length of the strips 102 is oriented mainly parallel to water flowing past the main deflector 22 when towing the trawl doors 20, 60 through water, and the width of the strips 102 is oriented mainly orthogonal to that water flow. Considering in this way the strips 102 depicted in FIG. 5, the strips 102 have the following longitudinal gap separating them, length and width.

Gap d=(0.010÷0.015)L where L is the length of the chord 36 of the main deflector 22

Length the distance between the leading edge 59 of the perforated slat 52, 52U and 52L and the trailing edge 58 thereof

Width Δd=(1.5÷2.0) where d=(0.01÷0.015)L

Width Δd=(0.015÷0.030)L

A corresponding complementary description of FIG. 7 in which circularly-shaped perforations 56 pierce the perforated slat 52, 52U and 52L is also possible. However, for such a description of the strips 102 their width is probably most conveniently characterized by the distance between immediately adjacent circularly-shaped perforations 56 while the longitudinal gap between immediately adjacent strips 102 is the diameter of the circularly-shaped perforations 56.

Gap d=(0.015÷0.025)L where L is the length of the chord 36 of the main deflector 22

Length the distance between the leading edge 59 of the perforated slat 52, 52U and 52L and the trailing edge 58 thereof

Width Δd=d where d=(0.015÷0.025)L

Width Δd=(0.015÷0.025)L

Correspondingly, detailed technical information appearing in the spreadsheet formed by FIGS. 11A-11D characterizes other aspects of the strips 102 in this complementary description of the improved trawl doors 20, 60 provided by this disclosure.

Equipping a trawl doors 20, 60 with the strips 102 betters at least a numerical value obtained by dividing a lift coefficient measured for the improved trawl doors 20, 60 when towed through water by a drag coefficient measured concurrently for the improved trawl doors 20, 60 in comparison with a corresponding numerical value obtained for a trawl door:
a. having a main deflector shaped identical to that of the improved trawl doors 20, 60; and
b. lacking the strips 102.

Yet another complementary perspective for describing the perforated slat 52, 52U and 52L is to note that the strips 102 together with interconnecting pieces of solid material 104 which span between immediately adjacent pairs of the strips 102 form a mesh. Accordingly, instead of describing the permeable structure depicted in FIGS. 1 through 8, 9A and 9B as a perforated slat 52, it would be equally proper and equivalent to describe it as a mesh.

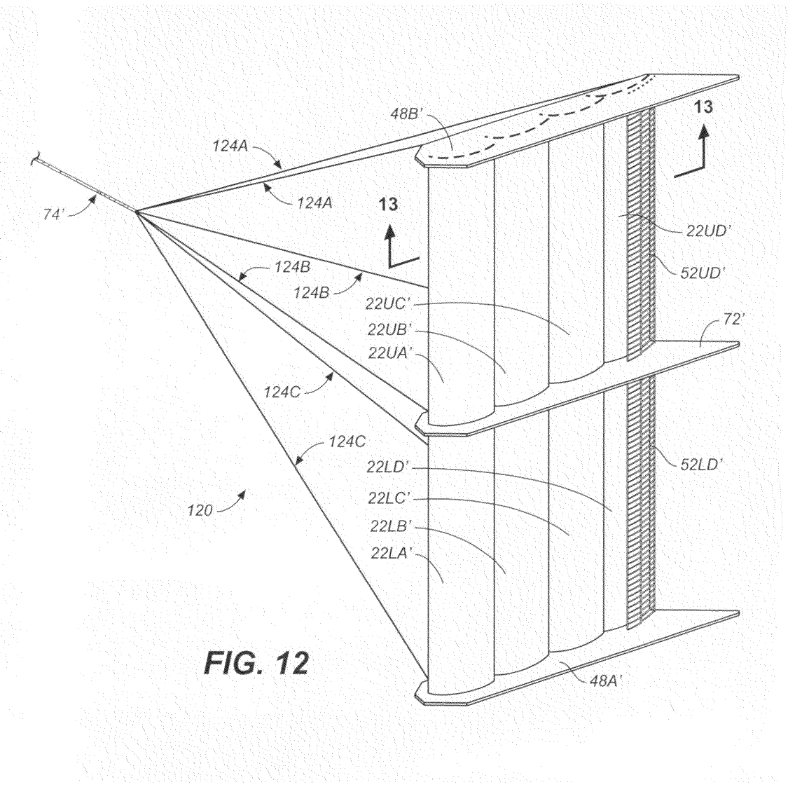

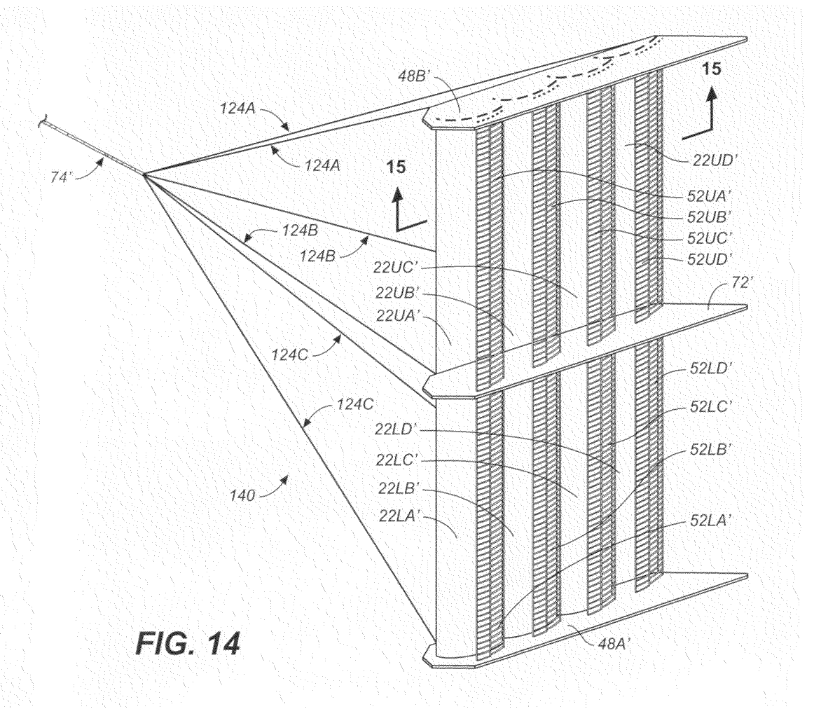

Pairs of FIGS. 12 and 13, and 14 and 15 respectively depict two (2) different configurations for paravanes that are adapted for use in spreading seismic surveillance arrays respectively referred to by the general reference characters 120 and 140. Those elements of the paravanes 120, 140 depicted in FIGS. 12 through 15 that are common to the trawl doors 20, 60 as depicted in FIGS. 1 through 8, 9A and 9B carry the same reference numeral distinguished by a prime (“′”) designation. As depicted in FIGS. 12 and 14, a pair of bridles 124A couple fore and aft locations on an upper end plate 48B′ respectively of the paravanes 120, 140 to a main towing warp 74′. Similarly, a pair of bridles 124B couple fore and aft locations on a center plate 72′ respectively of the paravanes 120, 140 to the main towing warp 74′. And finally a pair of bridles 124C couple fore and aft locations on a lower end plate 48A′ respectively of the paravanes 120, 140 to the main towing warp 74′.

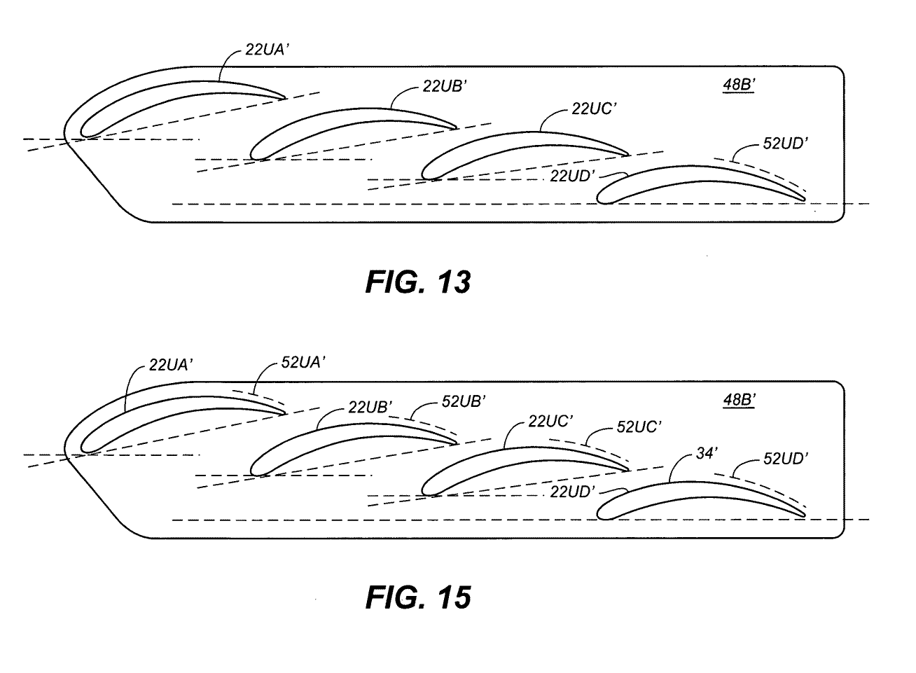

In FIGS. 12 and 13, the paravane 120 includes four (4) upper main deflectors 22UA′, 22UB′, 22UC′ and 22UD′ that are located between the upper end plate 48B′ and the center plate 72′. The paravane 120 also includes four (4) lower main deflectors 22LA′, 22LB′, 22LC′ and 22LD′ that are located between the center plate 72′ and the lower end plate 48A′. As depicted in FIGS. 12 and 13, only the upper main deflector 22UD and lower main deflector 22LD of the paravane 120 respectively have a perforated slat 52UD′ and perforated slat 52LD′ situated adjacent to and separated from the outer surfaces 34′ of the upper main deflector 22UD and lower main deflector 22LD respectively. Alternatively, as depicted in FIGS. 14 and 15, each of the upper main deflectors 22UA′, 22UB′, 22UC′ and 22UD′ included in the paravane 140 has a perforated slat 52UA′, 52UB′, 52UC′ and 52UD′ respectively situated adjacent to and separated from the outer surfaces 34′ of the upper main deflectors 22UA′, 22UB′, 22UC′ and 22UD′ respectively. Similarly, each of the lower main deflectors 22LA′, 22LB′, 22LC′ and 22LD′ included in the paravane 140 has a perforated slat 52LA′, 52LB′, 52LC′ and 52LD′ respectively situated adjacent to and separated from the outer surfaces 34′ of the lower main deflectors 22LA′, 22LB′, 22LC′ and 22LD′ respectively. While trawl doors 20, 60 usually include only a single main deflector 22, 22U, 22L, in principle the trawl doors 20, 60 could include several main deflectors 22, 24U, 24L similar to those depicted for the paravanes 120, 140.

Although the present disclosure has been described in terms of presently preferred embodiments, it is to be understood that such descriptions are purely illustrative and are not to be interpreted as limiting. The trawl door 20 illustrated respectively in FIGS. 1-8 and 10A and 10B is a pelagic (midwater) trawl door. However, a trawl door in accordance with the present disclosure may be a bottom trawl door, or a deflector used in seismic surveillance, where high angles of attack are common for the trawl door or deflector. Generally, a trawl door in accordance with the present disclosure may be similar to any trawl door construction known in the art with the addition of perforated slat 52, 52U and 52L. Accordingly, a trawl door in accordance with the present disclosure may be either Vee shaped or straight, and may, as well, include or omit one or both of the leading edge slats 42A and 42B, or include more than two (2) leading edge slats. Similarly, the main deflector 22 of a trawl door in accordance with the present disclosure may have a wing shape cross-sectional profile, and may include or omit mass weight plates, etc.

The disclosed improved trawl doors 20, 60 have more outboard weight than conventional trawl doors. To accommodate the greater outboard weight, the trawl doors 20, 60 must have the connection point for the main towing warp 74 positioned differently along the center plate 72 than for a conventional trawl door so improved trawl doors 20, 60 remain an upright with a lesser mass weight plate.

Furthermore, the position of backstrop holes 78 must be properly located so the trawl doors 20, 60 operate at a desired angle of attack, usually approximately thirty-seven degrees (37°) to forty degrees (40°). Because the trawl doors 20, 60 when operating at a high angle of attack increases trawl-mouth spreading force in comparison with the same characteristics exhibited by a conventional trawl door, correspondingly the larger trawl mouth opening applies more force to the backstrop holes 78 via the towing bridles 76L, 76U. Therefore, configuring the trawl doors 20, 60 to operate at a desired angle of attack requires properly positioning the backstrop holes 78 to compensate for the greater force applied to the trawl doors 20, 60 via the towing bridles 76L, 76U.

Consequently, without departing from the spirit and scope of the disclosure, various alterations, modifications, and/or alternative applications of the disclosure will, no doubt, be suggested to those skilled in the art after having read the preceding disclosure. Accordingly, it is intended that the following claims be interpreted as encompassing all alterations, modifications, or alternative applications as fall within the true spirit and scope of the disclosure.

1. An improved trawl door (20, 60) having at least one main deflector (22), the main deflector (22) having a profile formed by a cambered inner surface (32) and a cambered outer surface (34) which respectively span a chord (36) of the main deflector (22) extending between leading edges (24, 24U, 24L) and trailing edges (26, 26U, 26L) thereof,
the improved trawl door (20, 60) being characterized by including a perforated slat structure (52, 52U, 52L) disposed adjacent to and separated from the outer surface (34) of the main deflector (22), the perforated slat structure (52, 52U, 52L) having a plurality of apertures (54, 56) formed therethrough so the perforated slat structure (52, 52U, 52L) establishes a porous surface adjacent to the outer surface (34) of the main deflector (22).

2. The trawl door (20, 60) of claim 1 wherein the perforated slat structure (52, 52U, 52L) extends from more proximal the trailing edge (26, 26U, 26L) of the main deflector (22) than proximal the main deflector's leading edge (24, 24U, 24L), over at least a portion of the main deflector (22) and toward the leading edge (24, 24U, 24L) of the main deflector (22).

3. The trawl door (20, 60) of claim 2 wherein the perforated slat structure (52, 52U, 52L) extends longitudinally along the trailing edge (26, 26U, 26L) between opposite ends of the main deflector (22, 22U, 22L).

4. The trawl door (20, 60) of claim 2 wherein the high angle of attack exceeds thirty degrees (30°).

5. The trawl door (20, 60) of claim 2 wherein the high angle of attack exceeds thirty-five degrees (35°).

6. The trawl door (20, 60) of any one of claims 2 through 5 wherein longitudinal gaps (54) formed through sheet material forming the perforated slat structure (52, 52U, 52L) make the perforated slat structure (52, 52U, 52L) porous.

7. The trawl door (20, 60) of claim 6 wherein the longitudinal gaps (54) formed through the perforated slat structure (52, 52U, 52L) have a length to width ratio being selected from a group consisting of:
a) between 10:1 and 15:1; and
b) between 20:3 and 50:3.

8. The trawl door (20, 60) of claim 6 wherein at least one of the longitudinal gaps (54) formed through the perforated slat structure (52, 52U, 52L) has a shape being selected from a group consisting of a shape having:
a) at least one short end formed with a round-shape (112);
b) at least one short end formed with a prong-shape (114); and
c) at least one short end formed with a pointed-shape (116).

9. The trawl door (20, 60) of claim 6 wherein rectangularly-shaped perforations form the longitudinal gaps (54) formed through the perforated slat structure (52, 52U, 52L).

10. The trawl door (20, 60) of claim 6 wherein the longitudinal gaps include rectangularly-shaped perforations (54) formed through the perforated slat structure (52, 52U, 52L), the rectangularly-shaped perforations having a length to width ratio being selected from a group consisting of:
a) between 10:1 and 15:1; and
b) between 20:3 and 50:3.

11. The trawl door (20, 60) of claim 6 wherein the longitudinal gaps include rectangularly-shaped perforations (54) formed through the perforated slat structure (52, 52U, 52L), the rectangularly-shaped perforations having a shape being selected from a group consisting of a shape having:
a) at least one short end formed with a round-shape (112);
b) at least one short end formed with a prong-shape (114); and
c) at least one short end formed with a pointed-shape (116).

12. The trawl door (20, 60) of any one of claims 2 through 5 wherein circularly-shaped perforations (56) formed through sheet material forming the perforated slat structure (52, 52U, 52L) make the perforated slat structure (52, 52U, 52L) porous.

13. The trawl door (20, 60) of any one of claims 2 through 5 wherein an inner surface (32) of the perforated slat structure (52, 52U, 52L) that is immediately adjacent to the outer surface (34) of the main deflector (22, 22U, 22L) has substantially the same camber as the outer surface (34) of the main deflector (22, 22U, 22L).

14. The trawl door (20, 60) of any one of claims 2 through 5 wherein spacing between an inner surface (92) of the perforated slat structure (52, 52U, 52L) at a trailing edge (58) thereof to an immediately adjacent outer surface (34) of the main deflector (22, 22U, 22L) is between eighty-five percent (85%) and one-hundred and fifteen percent (115%) of spacing between the inner surface (92) of the perforated slat structure (52, 52U, 52L) at a leading edge (59) to an immediately adjacent outer surface (34) of the main deflector (22, 22U, 22L).

15. The trawl door (20, 60) of any one of claims 2 through 5 wherein spacing between an inner surface (92) of the perforated slat structure (52, 52U, 52L) at a trailing edge (58) thereof to an immediately adjacent outer surface (34) of the main deflector (22, 22U, 22L) is substantially identical to spacing between the inner surface (92) of the perforated slat structure (52, 52U, 52L) at a leading edge (59) to an immediately adjacent outer surface (34) of the main deflector (22, 22U, 22L).

16. The trawl door (20, 60) of any one of claims 2 through 5 wherein a total area of apertures (54, 56) formed through the perforated slat structure (52, 52U, 52L) is an area being selected from a group consisting of:
a) between twenty percent (20%) and forty percent (40%) of the perforated slat structure's overall area; and
b) between twenty percent (20%) and thirty percent (30%) of the perforated slat structure's overall area.

17. (canceled)

18. The trawl door (20, 60) of any one of claims 2 through 5 wherein a distance between the leading edge (24, 24U, 24L) of the main deflector (22, 22U, 22L) and a leading edge (59) of the perforated slat structure (52, 52U, 52L) parallel to the chord (36) of the main deflector (22, 22U, 22L) is between fifteen percent (15%) and sixty-five percent (65%) of a length of the chord (36) of the main deflector (22, 22U, 22L).

19. The trawl door (20, 60) of any one of claims 2 through 5 wherein a distance between the leading edge (24, 24U, 24L) of the main deflector (22, 22U, 22L) and a leading edge (59) of the perforated slat structure (52, 52U, 52L) parallel to the chord (36) of the main deflector (22, 22U, 22L) is a distance being selected from a group consisting of:
a) between twenty-five percent (25%) and thirty percent (30%) of the length of the chord (36) of the main deflector (22, 22U, 22L);
b) between twenty percent (20%) and thirty-five percent (35%) of the length of the chord (36) of the main deflector (22, 22U, 22L); and
c) between thirty percent (30%) and sixty percent (60%) of the length of the chord (36) of the main deflector (22, 22U, 22L).

20-21. (canceled)

22. The trawl door (20, 60) of claim 1 wherein the perforated slat structure is formed by a plurality of elongated strips (102) of solid material that are separated by a longitudinal gap therebetween, the elongated solid material strips (102) having both a length and a width, the length of a plurality of the elongated solid material strips (102) configured so as to be oriented mainly parallel to water flowing past the main deflector (22, 22U, 22L) when towing the improved trawl door (20, 60) through water, and the width of a plurality of the elongated solid material strips (102) configured so as to be oriented mainly orthogonal to water flowing past the main deflector (22, 22U, 22L) when towing the improved trawl door (20, 60) through water.

23. The trawl door (20, 60) according to any one of claims 2 to 5 wherein the perforated slat structure (52) is preferably secured to the main deflector (22) via support structures welded at selected locations along its length.

24. The trawl door (20, 60) according to any one of claims 2 to 5 wherein the trawl door includes upper and lower sections (62, 64) joined relative to one another such that exterior surfaces of the trawl door upper and lower sections lie in different planes.

25. The trawl door (20, 60) of claim 24 wherein the perforated slat structure is secured to the main deflector 22 via support structures welded at selected locations along its length.

26-36. (canceled)

37. A method for producing caught fish comprising the steps of:
a) forming a trawl door (20, 60) having at least one main deflector (22), the main deflector (22) having a profile formed by a cambered inner surface (32) and a cambered outer surface (34) which respectively span a chord (36) of the main deflector (22) extending between leading edges (24, 24U, 24L) and trailing edges (26, 26U, 26L) thereof, the trawl door (20, 60) including perforated slat structure (52, 52U, 52L) disposed adjacent to and separated from the outer surface (34) of the main deflector (22), the perforated slat structure (52, 52U, 52L) having a plurality of apertures (54, 56) formed therethrough so the perforated slat structure (52, 52U, 52L) establishes a porous surface adjacent to the outer surface (34) of the main deflector (22);
b) attaching the trawl door to a trawler and also to a trawl net; and
c) trailing the trawl net so as to gather fish with the trawl net.

38. The method of claim 37 wherein the step of forming the trawl door (20, 60) includes the additional step of forming the perforated slat structure (52, 52U, 52L) so that the perforated slat structure extends from more proximal the trailing edge (26, 26U, 26L) of the main deflector than proximal the main deflector's leading edge (24, 24U, 24L), over at least a portion of the main deflector and toward the leading edge (24, 24U, 24L) of the main deflector.

39. The method according to any one of claims 37 to 38 wherein the method includes the further step of forming the trawl door such that the trawl door includes upper and lower sections (62, 64) joined relative to one another such that exterior surfaces of the trawl door upper and lower sections lie in different planes.
